(19) United States
(12) Patent Application Publication
(10) Pub. No.: US 2007/0023505 A1
(43) Pub. Date: Feb. 1, 2007

(54) Automatic condiment dispenser

(76) Inventors: David A. Norton, Tampa, FL (US); Carl E. Treankler, Little Suamico, WI (US); Terry L. Hanstedt, Pulaski, WI (US); Gary S. Lofquist, Little Suamico, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/190,993

(22) Filed: Jul. 27, 2005

(51) Int. Cl. G06F 7/08; G06F 17/00

(52) U.S. Cl. 235/381; 235/375

(57) ABSTRACT

A system for dispensing a predetermined number of prepackaged condiments to a customer based on a food order inputted into a business machine at a food service establishment. The system includes a business machine, such as a cash register, linked to a powered prepackaged condiment dispenser. Each menu item available at the establishment is assigned a number that represents the total number of prepackaged condiments that a normal customer may need while consuming the item. A microprocessor contained within either the dispenser or the business machine retrieves the number of condiments from the memory when a food item key is pressed and provides a signal to the condiment dispenser so that the predetermined number of prepackaged condiments is dispensed. The system controls the amount of prepackaged condiments provided to the customer in order to reduce waste.

### BACKGROUND OF THE INVENTION

The present invention generally relates to a method and apparatus for dispensing prepackaged condiments. More particularly, the present invention relates to a method and apparatus for automatically dispensing a predetermined number of prepackaged condiments in response to a food order entered into a cash register or other similar business machine.

Many food service establishments, such as fast food restaurants, offer service at a counter or in a cafeteria setting. These establishments typically furnish prepackaged condiments, such as ketchup or mustard, to their customers for use in eating their food items. These prepackaged condiments are either freely available to the customers from bins throughout the restaurant or are presented to the customers at the counter when the customers receive the items of their food order. Regardless of how the prepackaged condiments are dispensed to the customer, customers often take more condiments than needed, which results in waste that increases the restaurant operating costs.

When manual dispensers located throughout the restaurant are used, the management has no control over the number or volume of the condiments that each customer takes. As a result, customers can take as many as they wish. Typically, customers take more of a condiment, for example ketchup, than they will use while eating their food order. The customer, or the person cleaning the table, then discards the extra, unused condiments. Alternatively, the customer may keep the extra prepackaged condiments and use them elsewhere, such as in their office or automobile. As a result, perfectly clean, unused prepackaged condiments are left laying around the restaurant creating an unattractive appearance or are taken for purposes not related to the restaurant that paid for them.

In an attempt to prevent the waste of prepackaged condiments, many restaurants have stopped using manual, customer accessible dispensers, and instead now rely on their cashiers to dispense the prepackaged condiments. It was anticipated that a cashier would provide a customer with only the fewest number of prepackaged condiments necessary. Unfortunately, cashiers often times do not accurately control the number of prepackaged condiments provided to the customer. Moreover, cashiers typically do not provide a commensurate number of prepackaged condiments for the ordered food. Instead, cashiers typically just reach for the prepackaged condiments and provide a random number to the customer without considering the type of food items ordered or the size of the portion. Consequently, when the cashiers are not paying attention or have poor judgment, they can also cause prepackaged condiment waste by providing the customer with more than needed. Alternatively, cashiers may upset the customers by not providing a sufficient number of prepackaged condiments needed to consume the food order. Additionally, by requiring the staff to dispense the prepackaged condiments, the speed of the service provided to the customer is reduced. This can cause the customers to become upset and impatient while in line. Additionally, it may discourage the customers from staying in line and/or returning to the restaurant.

It is an object of the present invention to provide a prepackaged condiment dispenser control system that causes a prepackaged condiment dispenser to deliver a predetermined number of a prepackaged condiment to a customer. The predetermined number of condiments is based on the size of the food item ordered, the type of food ordered and/or the total number of items ordered.

It is another object of the invention to provide an integrated dispenser and business machine system that will control the number of prepackaged condiments delivered to the customer without occupying the time and attention of the clerk.

### SUMMARY OF THE INVENTION

The present invention generally relates to a system for dispensing a predetermined number of prepackaged condiments based on the items of a food order inputted into a business machine at a food service establishment. The system includes a business machine, such as a cash register, linked to a powered prepackaged condiment dispenser. According to the present invention, each food item available off of the menu at the establishment is assigned a number that represents the total number of ketchup, mustard or other prepackaged condiment that a normal customer may need while consuming the ordered food item. This assigned number is stored within a memory, such as a read-only memory (ROM) or a random-access memory (RAM). Upon receiving a request for a food item, the cashier inquires as to whether the customer desires each of several condiment types, such as ketchup and mustard. If the customer desires one or more type of condiment, the cashier depresses a corresponding condiment key on the business machine. Alternatively, the condiment dispenser could be configured to automatically dispense a condiment, such as ketchup, upon an order for a food item, such as french fries.

A microprocessor contained within either the powered prepackaged condiment dispenser or the integrated business machine retrieves a command from the memory when a food item key and a condiment key on the business machine is pressed. The microprocessor add the number of condiments required for the entire food order and provides a signal to the condiment dispenser to deliver the predetermined number of the prepackaged condiments to the customer. The system controls the dispensing of the prepackaged condiments in order to reduce the number of needlessly wasted, unused prepackaged condiments.

### BRIEF DESCRIPTION OF THE DRAWINGS

FIG. 1 is a schematic diagram of prepackaged condiment dispensing system including a business machine and an automatic prepackaged condiments dispenser; and

FIG. 2 is block diagram of the prepackaged condiment dispensing system coupled to a business machine.

### DETAILED DESCRIPTION OF THE PREFERRED EMBODIMENT

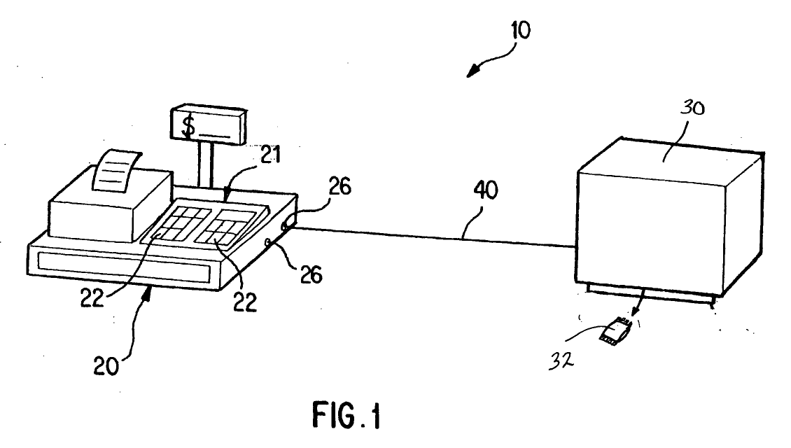

FIG. 1 illustrates a schematic overview of an integrated business machine and prepackaged condiment dispensing system 10 that can be used in the food service industry for delivering a predetermined number of prepackaged condiments to a food service customer. For example, when an order for a small french fries is entered into the business machine, the cashier is prompted to ask whether the customer would like a condiment, such as ketchup. If the customer expresses a desire for the condiment, a key on the business machine is depressed and a single ketchup packet will be dispensed. If an order for a large french fries is entered, three or four ketchup packets may be dispensed. In the preferred embodiment of the invention, the customer is queried as to whether a condiment is desired prior to the dispenser delivering the condiment. Although asking the customer if a condiment is desired will reduce wasted condiments, the system could also be configured to dispense condiments automatically upon entry of an order for a food item without a customer query.

The prepackaged condiments referred to in the present description can include any known prepackaged condiments available in the food service industry and used by a customer during a meal. These prepackaged condiments can be supplied as a bulk of individual packets of prepackaged condiments or as continuous strips of prepackaged condiments connected end to end. Most commonly, the individual packets are separate and supplied in bulk. A continuous strip of prepackaged condiments includes multiple units each separated by tearing lines. By using a perforated strip of packets, the prepackaged condiments can be separated easily from the remainder of the strip along a substantially jagged edge after being dispensed. For convenience and clarity, the above-discussed ketchup packets, mustard packets or any other condiment packets will be hereinafter referred to as “prepackaged condiments.”

System 10 includes a business machine 20, such as an electronic cash register 20, a point of sale terminal or similar machine into which a customer's food order is entered at a counter in a food service establishment. For simplicity, the following discussion will be directed to a cash register. However, the discussed principles are equally applicable to other known business machines. System 10 also includes a prepackaged condiment dispenser 30 which is electronically linked to, and cooperates with, the cash register 20 for providing a predetermined number of prepackaged condiments 32 to customers after their food orders have been processed. Although the condiment dispenser 30 is shown linked to only a single cash register 20, it is contemplated that the condiment dispenser 30 could be linked to multiple cash registers.

The present invention can be used with any type of automatic prepackaged condiment dispenser. However, for clarity of explanation, it will be discussed as it relates to an automatic dispenser for separate packages of condiments contained in a storage bin or container. The principles discussed below are equally applicable to other automatic prepackaged condiments dispenser for continuous strips, stacked or otherwise arranged prepackaged condiments.

As shown in FIG. 1, the cash register 20 according to the present invention includes a keypad 21 with individual function, numeric and/or menu item keys 22. Each of these keys 22 is mapped or otherwise linked to a program in a memory, such as a RAM or a ROM, as is known in conventional cash register technology. The program in memory includes a list of different information or commands that are assigned to each of the keys. These commands may include the price of the item, the name of the item and a predetermined number of prepackaged condiments to be dispensed to the customer upon entry of each food item on the restaurant menu, where the number of condiments is based on its size and/or food type. As used herein, “food” includes both solid and liquid food. For example, a regular hamburger may be assigned the number “1” which means that the dispenser 30 will be operated to deliver one packet of ketchup and/or one packet of another condiment type to the customer. Whereas, a large order of french fries will be assigned the number “3”. The number “3” means that three packets of ketchup will be delivered to the customer. As a further example, the “jumbo size” of a menu item may be assigned an even greater number of packets than the standard size of the same menu item. The assigned number for each food item on a menu of items is inputted into the memory of the cash register or another memory within the system 10, such as a memory chip in the dispenser 30, before the item is introduced into the menu. The stored number of condiments for each food item can then later be accessed upon entry of a food order to dispense the correct number of condiments to the customer. Other commands can also be assigned to each key and stored within one of these memories.

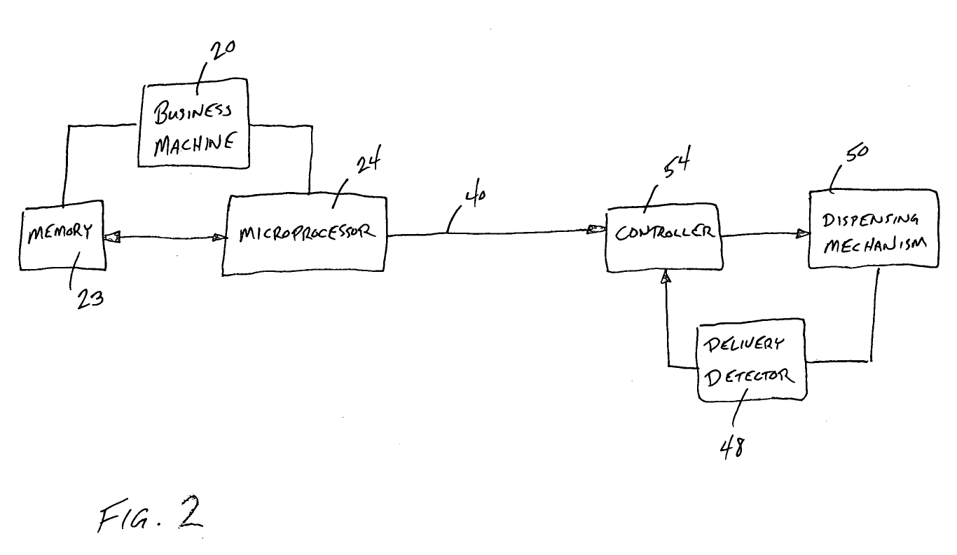

Although the specific operating components of the condiment dispenser 30 utilized in accordance with the present invention are not shown in the figures, it should be understood that various types of condiment dispensers can be utilized while operating within the scope of the present invention. Preferably, each condiment dispenser 30 will include some type of storage bin or area that stores a supply of condiments to be dispensed. The condiment dispenser will include some type of driven device operable to expel packets from the storage bin. In a preferred embodiment of the invention, the condiment dispenser will include an output sensor that can detect when each packet 32 of the condiment is expelled from the storage bin. Information regarding the number of condiment packets 32 expelled from the dispenser 30 is relayed to the controller 54 shown in FIG. 2. The controller 54 is coupled to a dispensing mechanism 50 to dispense additional condiment packets if required. The delivery detector 48 will most likely include a photo emitter/photo detector pair, as is well known in the material handling art.

In addition to a delivery detector 48 that detects when a packet 32 is expelled from the storage bin, it is contemplated that the condiment dispenser 30 should also include a level indicator that monitors the volume of condiment packets within the storage bin. If the level of condiment packets within the storage bin drops below a minimum level, an empty or low level indicator would be activated, indicating that the storage bin should be refilled.

The condiment dispenser 30 includes a delivery detector 48 that is responsive to a packet 32 being delivered. The delivery detector 48 is coupled to the controller 54 to allow the controller 54 to ascertain that an article has been delivered to a user. The controller 54 is able to terminate operation of the dispensing mechanism 50 upon detection of the delivery of a packet 32 by the delivery detector 48.

Thus, in the preferred embodiment of the invention, when the microprocessor contained within the business machine 20 requests a desired number of the prepackaged condiments, the request is relayed to the controller 54 over the communication line 40. Upon receiving the number of condiments, the controller 54 activates the dispensing mechanism 50 to begin delivering the required number of packets 32. The delivery sensor 48 detects the discharge of each packet 32 and relays this information to the controller 54. Once the desired number of packets has been dispensed, the controller 54 terminates operation of the dispensing mechanism. It is contemplated that the controller 54 can keep a running count of the number of packets dispensed over a given time period.

As illustrated in FIG. 2, the cash register 20 also includes a well-known microprocessor 24 that receives the assigned information for a depressed key from the memory 23 and sends a signal or data to an appropriate location within the restaurant via a data port 26 (FIG. 1) or a network port on the cash register 20. For example, the microprocessor 24 can send the stored data concerning the price of the item to another memory chip in the cash register 20; it can send the name and other information about the item to a food preparation station so that the order can be filled. The microprocessor 24 contained within the cash register 20 can also send a signal or data to the dispenser 30 via a data transfer line 40 or remote control using known sensors, such as infrared sensors. Data transfer line 40 extends from the data port 26 on the cash register 20 to a similar port on the dispenser 30. Although a wired connection is shown, the transfer line 40 could be replaced by a wireless communication link. The signal or data from microprocessor 24 can be interpreted by the controller 54 within the prepackaged condiments dispenser 30 to cause the activation of the dispensing mechanism 50 and the delivery of the predetermined number of prepackaged condiments to the customer.

In operation, when a customer orders a particular menu item, the corresponding key on the cash register 20 is pressed. In one preferred embodiment, the customer is then asked whether the customer would like a condiment and what type of condiment they would prefer. Based on this information, the cashier depresses another key or keys on the cash register. Alternatively, the system could be configured to dispense a specific condiment, such as ketchup, automatically upon entry of a food item, such as french fries.

The microprocessor 24 within the cash register 20 responds by executing a software routine. Initially, the microprocessor 24 utilizes the identification of the particular key that was pressed to access a table within a memory that contains the information about that ordered food item. This information concerning the predetermined number of prepackaged condiments that are to be delivered is then accessed and interpreted by the microprocessor 24. The information, including the number and type of condiment to be disposed, is then sent to the controller 54 within dispenser 30.

The controller 54 is connected to the dispensing mechanism 50 and controls its operation. The controller 54 sends an activation signal to the mechanism 50 causing it to operate and dispense the predetermined number of prepackaged condiments. As the condiments are dispensed, the delivery detector 48 counts the packets and stops operation of the dispensing mechanism once the predetermined number has been reached. The dispensing mechanism 50 will then remain at rest until another menu item has been selected, and information for that selection has been provided. It is also contemplated that the number of prepackaged condiments for each selected item be stored in a memory and the total number of prepackaged condiments for all of the ordered items be dispensed at a single time after the entire order has been completed, not after each item has been individually entered, as discussed above.

The above-described invention relates to a method and device for dispensing a preset number of prepackaged condiments based on the food items ordered. The number of prepackaged condiments that are dispensed with each of the above-discussed food items is merely exemplary and does not limit the invention. While the invention has been described in the manner presently conceived to be most practical and a preferred embodiment thereof, it will be apparent to persons ordinarily skilled in the art that modifications may be made thereof within the scope of the invention, which scope is to be accorded the broadest interpretation of the claims such as to encompass all equivalents, devices, and methods. For example, the microprocessor and memory that stores all of the information concerning the number of prepackaged condiments to dispense can both be located within the dispenser 30. In this embodiment, the microprocessor 24 would merely send a signal to the controller 54 that contains the name of the ordered item. The controller 54 would then access a memory chip in the dispenser 30 and obtain the information regarding the number of prepackaged condiments that should be dispensed and/or the related number of pulses that should be counted. The controller 54 would then drive the dispensing mechanism 50 so that the predetermined number of prepackaged condiments was dispensed. The operation and timing of the dispensing mechanism 50 and the other parts of the invention would be the same as discussed above.

What is claimed is:

1. A system for automatically dispensing prepackaged condiments, the system comprising:
a business machine for processing food service orders;
a powered prepackaged condiment dispenser including a housing having a discharge opening and a dispensing mechanism for delivering the prepackaged condiments within the housing to the discharge opening,
wherein the business machine communicates with the powered prepackaged condiment dispenser so that a predetermined number of a prepackaged condiments are delivered to the discharge opening in response to a size or type of food item order being entered into the business machine.

2. The system according to claim 1 wherein the business machine comprises a cash register.

3. The system according to claim 1 wherein the powered prepackaged condiment dispenser includes a detector for determining the number of prepackaged condiments that have been dispensed.

4. The system according to claim 1 wherein the condiment dispenser includes a controller that controls the operation of the condiment dispenser in response to a signal received from the business machine.

5. The system according to claim 1 further comprising a memory for storing information regarding the predetermined number of prepackaged condiments to be dispensed for each food item on a food menu.

6. The system of claim 1 wherein the business machine is connected to the powered prepackaged condiment dispenser for delivering a signal to the prepackaged condiment dispenser in response to an inputted food order.

7. The system of claim 2 wherein the cash register communicates with the powered prepackaged condiment dispenser such that an information signal regarding at least one of a food portion size and type of food in a food order can be delivered from the cash register to the powered prepackaged condiment dispenser.

8. A system for automatically dispensing prepackaged condiments in response to a food order, the system comprising:
a business machine including an entry system for entering at least a food order and a customer's desire for the prepackaged condiment;
a powered condiment dispenser connected to the business machine for receiving a signal from the business machine in response to an entered food order, the condiment dispenser being operable to dispense a predetermined number of the prepackaged condiments assigned to each item on a menu based on at least the size or type of food order and the customer's desire for the condiment.

9. The system according to claim 8 wherein the business machine is a cash register.

10. The system according to claim 9 wherein the cash register is operatively connected to the condiment dispenser such that an information signal regarding at least one of a food portion size and type of food in a food order can be generated by the cash register and received by the condiment dispenser.

11. The system of claim 10 wherein the condiment dispenser includes a detector for determining the number of prepackaged condiments that have been dispensed in response to a signal received from the cash register.

12. The system according to claim 10 wherein at least one of the condiment dispenser and the cash register comprise a memory for storing information regarding the predetermined number of prepackaged condiments to be dispensed for each item on a food menu.

13. A method of dispensing prepackaged condiments comprising the steps of:
assigning a predetermined number of prepackaged condiments to at least one food item on a menu of items;
entering a food service order including the food item into a business machine;
entering the customer's desire for at least one condiment;
processing the food service order;
providing information about the food service order and the customer's desire for condiments from the business machine to a condiment dispenser;
operating the condiment dispenser to dispense a predetermined number of condiments based upon the entered food order.

14. The method according to claim 13 further comprising the step of accessing in memory and obtaining information about the predetermined number of prepackaged condiments for the food item.

15. The method according to claim 13 further comprising the step of accessing the number of prepackaged condiments dispensed and interrupting operation of the condiment dispenser upon dispensing the predetermined number of condiments.
